(19) United States
(12) Patent Application Publication
(10) Pub. No.: US 2026/0078017 A1
(43) Pub. Date: Mar. 19, 2026

(54) METAL COMPOSITE COMPOUND

(71) Applicant: TANAKA CHEMICAL CORPORATION, Fukui (JP)

(72) Inventors: Ayaka NAKAYA, Fukui-shi (JP); Tomoya KURODA, Fukui-shi (JP)

(21) Appl. No.: 19/320,828

(22) Filed: Sep. 5, 2025

(30) Foreign Application Priority Data
Sep. 19, 2024 (JP) 2024-162607

(51) Int. Cl. C01G 53/84; H01M 4/02; H01M 4/525

(52) U.S. Cl. CPC C01G 53/84; H01M 4/525; C01P 2002/85; C01P 2004/03; C01P 2004/61; C01P 2004/62; C01P 2006/40; H01M 2004/021

(57) ABSTRACT

A metal composite compound includes at least Ni. In a scatter plot obtained by measuring a powder of the metal composite compound using a scanning electron microscope-energy dispersive X-ray spectroscopy, with a horizontal axis representing a projected area circle equivalent diameter (μm) of particles of the metal composite compound and a vertical axis representing an Ni content ratio (mol %) of the particles of the metal composite compound, a slope S of an approximate straight line calculated by a least squares method is more than 0.2. When a particle diameter at which a cumulative volume ratio from a small particle side in a volume-based particle size distribution reaches 10% is defined as D₁₀ (μm), a standard deviation X of the Ni content ratio (mol %) in particles having a projected area circle equivalent diameter of the D₁₀ (μm) or less is 1.6 mol % or more.

### TECHNICAL FIELD

The present invention relates to a metal composite compound.

Priority is claimed on Japanese Patent Application No. 2024-162607, filed Sep. 19 2024, the content of which is incorporated herein by reference.

### BACKGROUND ART

A positive electrode active material contained in a positive electrode of a lithium secondary battery is obtained, for example, by mixing a lithium compound and a metal composite compound containing a metal element other than Li, followed by firing.

As the applications of lithium secondary batteries expand, there is a demand for improving the battery performance of lithium secondary batteries. As a technique for improving the battery performance of lithium secondary batteries, attempts have been made to control the physical properties of metal composite compounds serving as the raw materials for the cathode active materials.

For example, Patent Document 1 discloses that a lithium metal oxide powder produced using a precursor with specified D₁₀ and D₉₀ as a raw material can provide a lithium secondary battery with high safety and high power.

### PATENT DOCUMENTS

### Patent Document

[Patent Document 1] Japanese Unexamined Patent Application, First Publication No. 2012-43794

### SUMMARY OF THE INVENTION

### Technical Problem

As the fields of application of lithium secondary batteries expand, there is a demand for improvements in the durability of lithium secondary batteries.

The present invention has an object to provide a metal composite compound capable of producing a lithium secondary battery with high durability.

### Solution to Problem

The present invention includes the following [1] to [4].
[1] A metal composite compound containing at least Ni, in which in a scatter plot obtained by measuring a powder of the aforementioned metal composite compound using a scanning electron microscope-energy dispersive X-ray spectroscopy, with a horizontal axis representing a projected area circle equivalent diameter (μm) of particles of the aforementioned metal composite compound and a vertical axis representing an Ni content ratio (mol %) of the particles of the aforementioned metal composite compound, a slope S of an approximate straight line calculated by a least squares method is more than 0.2; and when a particle diameter at which a cumulative volume ratio from a small particle side in a volume-based particle size distribution reaches 10% is defined as D₁₀ (μm), a standard deviation X of the Ni content ratio (mol %) in particles having a projected area circle equivalent diameter of the aforementioned D₁₀ (μm) or less is 1.6 mol % or more.
[2] The metal composite compound according to [1], wherein when a particle diameter at which the cumulative volume ratio from the small particle side in the aforementioned particle size distribution reaches 50% is defined as D₅₀ (μm), a ratio of the aforementioned X and a standard deviation Y of the Ni content ratio (mol %) in particles having a projected area circle equivalent diameter of the aforementioned D₅₀ (μm) or more is 3.0 or more.
[3] The metal composite compound according to [1] or [2], wherein D₅₀ (μm), which is a particle diameter at which the cumulative volume ratio from the small particle side in the aforementioned particle size distribution reaches 50%, is 4 μm or more and 20 μm or less; a ratio (D₁₀/D₅₀) of the aforementioned D₁₀ (μm) with respect to the aforementioned D₅₀ (μm) is 0.3 or more and 0.8 or less; and when a particle diameter at which the cumulative volume ratio from the small particle side in the volume-based cumulative particle size distribution reaches 90% is defined as D₉₀ (μm), a ratio (D₉₀/D₅₀) of the aforementioned D₉₀ (μm) with respect to the aforementioned D₅₀ (μm) is 1.4 or more and 1.8 or less.
[4] The metal composite compound according to any one of [1] to [3], which is represented by the following formula (I):

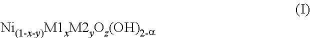

(in the formula (I), 0≤x≤0.8, 0≤y≤0.2, 0<x+y<1, 0≤z≤3, −0.5≤α≤2, and α−z<2; M1 is one or more elements selected from the group consisting of Co, Mn, and Al; and M2 is one or more elements selected from the group consisting of Fe, Cu, Ti, Mg, Zn, Sn, Zr, Nb, Ga, W, Mo, B, and Si.)

### Effects of the Invention

According to the present invention, a metal composite compound capable of producing a lithium secondary battery with high durability can be provided.

### DETAILED DESCRIPTION OF THE INVENTION

In the present specification, a metal composite compound is hereinafter referred to as “MCC” and a cathode active material for lithium secondary batteries is hereinafter referred to as “CAM”.

Further, when described as “MCC particle”, the term means a single MCC particle, and when described as “MCC”, the term means an MCC powder, which is an aggregate of MCC particles.

“Ni” refers to nickel atoms, and not a nickel metal. Similarly, “Co”, “Li” and the like also refer to cobalt atoms, lithium atoms, and the like, respectively.

When a numerical range is described as, for example, “1-10 μm” or “from 1 to 10 μm,” it means a range from 1 μm to 10 μm, and refers to a numerical range including 1 μm as the lower limit value and 10 μm as the upper limit value.

### [Measurement of Cycle Retention Rate]

In the present specification, whether or not a lithium secondary battery has high durability is evaluated by measuring a cycle retention rate of the lithium secondary battery.

In the present specification, the term “cycle retention rate” refers to a value measured by producing a lithium secondary battery using the following method and conducting a test in which this lithium secondary battery is subjected to 50 repeated charge-discharge cycles under the conditions shown below.

A lithium secondary battery is produced using the following method, and the cycle retention rate is measured.

### 1. Production of CAM

MCC and a lithium hydroxide monohydrate powder are weighed and mixed in a ratio such that a molar ratio of Li contained in the lithium hydroxide monohydrate powder with respect to a total amount of 1 of elements other than oxygen atoms contained in MCC (for example, Ni, an element M1 or element M2 described later) is 1.02 to obtain a mixture. The obtained mixture is fired at 650° C. for 5 hours in an oxygen atmosphere, and then fired at 750° C. for 5 hours in an oxygen atmosphere to obtain CAM.

### 2. Production of Positive Electrode for Lithium Secondary Battery

CAM, a conductive material (acetylene black) and a binder (PVdF) are added and kneaded in a ratio such that a composition of CAM:conductive material:binder=92:5:3 (mass ratio) to prepare a paste-like positive electrode mixture. N-methyl-2-pyrrolidone is used as an organic solvent at the time of preparing the positive electrode mixture.

The obtained positive electrode mixture is applied to a 40 μm thick Al foil that serves as a current collector and vacuum dried at 150° C. for 8 hours to obtain a positive electrode for a lithium secondary battery. The electrode area of this positive electrode for a lithium secondary battery is set to 1.65 cm².

### 3. Production of Lithium Secondary Battery

The following operations are carried out in a glove box with an argon atmosphere.

The positive electrode for a lithium secondary battery produced in the above section (2. Production of positive electrode for lithium secondary battery) is placed on a lower lid of a part for a coin-type battery R2032 (for example, manufactured by Hohsen Corporation) with the aluminum foil surface facing down, and a separator (porous film made of polyethylene) is placed thereon. 300 μl of an electrolytic solution is injected thereinto. As the electrolytic solution, a liquid obtained by dissolving LiPF₆ in a ratio of 1.0 mol/L in a mixed solution containing ethylene carbonate, dimethyl carbonate, and ethyl methyl carbonate in a volume ratio of 30:35:35 is used.

Next, using metallic lithium as a negative electrode, the negative electrode is placed on the upper side of the separator, covered with an upper lid through a gasket, and an upper lid was placed through a gasket and caulked using a caulking machine, thereby producing a lithium secondary battery (coin-type half cell R2032).

### (Charge-Discharge Cycle Test)

Test temperature: 25° C.

Maximum charge voltage: 4.3 V, charge current: 0.5 CA, constant current/constant voltage charge

Minimum discharge voltage: 2.5 V, discharge current: 1 CA, constant current discharge

A value calculated by dividing the discharge capacity at the 50th cycle by the discharge capacity at the 1st cycle is taken as the cycle retention rate (%).

In the present embodiment, scanning electron microscope-energy dispersive X-ray spectroscopy is referred to as “SEM-EDX”. As a scanning electron microscope-energy dispersive X-ray spectroscopic device, for example, a Schottky field emission scanning electron microscope (JSM-7900F (product name), manufactured by JEOL Ltd.) equipped with X-Max 150 (manufactured by Oxford Instruments plc) as an EDX detector can be used.

In addition, the SEM-EDX analysis is performed by SEM-EDX at an acceleration voltage of 15 kV and a resolution of 119 nm.

### <Metal Composite Compound>

In the present embodiment, MCC contains at least Ni. One example of MCC is a hexagonal system compound having a layered structure. Examples of MCC include a metal composite oxide, a metal composite hydroxide, or a mixture thereof. The metal composite hydroxide may also include a partially oxidized compound.

One aspect of the MCC particle is a secondary particle that is an aggregate of primary particles.

In a scatter plot obtained by measuring MCC with SEM-EDX, with a horizontal axis representing a projected area circle equivalent diameter (μm) of the MCC particles and a vertical axis representing an Ni content ratio (mol %) of the MCC particles with respect to the projected area circle equivalent diameter, the slope of an approximate straight line calculated by the least squares method is more than 0.2. Hereinafter, this slope may be abbreviated as “S”.

Further, in a volume-based particle size distribution of MCC, when the particle diameter at which the cumulative volume ratio from the small particle side reaches 10% is defined as D₁₀ (μm), a standard deviation X (mol %) of an Ni content ratio in MCC particles whose projected area circle equivalent diameter is D₁₀ (μm) or less is 1.6 mol % or more.

### [Measurement of S, X, and Y]

When measuring MCC with SEM-EDX, MCC particles that fall within the measurement field of view are randomly selected using the automatic extraction function of the SEM-EDX device, and calculation of the projected area circle equivalent diameter of the MCC particles and measurement of the Ni content ratio are performed. At this time, the measurement field of view is changed until 50 or more MCC particles that respectively satisfy the following (i) to (iii) are measured, and a total of 300 or more particles are measured, and the automatic particle extraction and the measurement of the projected area circle equivalent diameter and Ni content ratio of the MCC particles are repeated.
(i) Particles having a projected area circle equivalent diameter of 7 μm or less.
(ii) Particles having a projected area circle equivalent diameter of more than 7 μm and not more than 10 μm.
(iii) Particles having a projected area circle equivalent diameter of more than 10 μm.

For the measurement of MCC particles, for example, if 50 particles of (i), 150 particles of (ii), and 100 particles of (iii) are extracted and the Ni content ratio of each particle is measured, these can be used for calculating S, X, and Y.

It should be noted that if a predetermined number of MCC particles satisfying the above (i) to (iii) do not come into view even when a total of 5,000 particles are extracted, it is considered that no MCC particles satisfying the above (i) to (iii) are detected to fall outside the scope of the present invention.

When MCC particles are extracted based on the projected area circle equivalent diameters in the above (i) to (iii), the entire MCC can be roughly divided into large particles, medium sized particles, and small particles, and the characteristics obtained for each division can be judged as the characteristics for each particle size.

The surface of MCC is measured by SEM-EDX to respectively obtain the projected area circle equivalent diameter of the MCC particles contained in MCC and the Ni content ratio (mol %) of the MCC particles.

Further, when the particle diameter at which the cumulative volume ratio from the small particle side in a volume-based particle size distribution of MCC reaches 10% is defined as D₁₀ (μm), a standard deviation X (mol %) of an Ni content ratio in particles whose projected area circle equivalent diameter of MCC particles is D₁₀ (μm) or less is obtained.

Furthermore, when the particle diameter at which the cumulative volume ratio from the small particle side in the volume-based particle size distribution of MCC reaches 50% is defined as D₅₀ (μm), a standard deviation Y (mol %) of the Ni content ratio in particles whose projected area circle equivalent diameter of MCC particles is D₅₀ (μm) or more is obtained.

In order to obtain S, a scatter plot is created in which the projected area circle equivalent diameter (μm) is plotted on the horizontal axis and the Ni content ratio (mol %) with respect to the projected area circle equivalent diameter is plotted on the vertical axis.

In the obtained scatter plot, S is obtained as the slope of the approximate straight line calculated using the least squares method.

In the present embodiment, S is more than 0.2, and is preferably equal to or more than 0.22, more preferably equal to or more than 0.24, and still more preferably equal to or more than 0.26.

The upper limit value of S is not particularly limited, but is, for example, 1.0 or less, 0.8 or less, 0.6 or less, or 0.4 or less.

The above lower limit values and upper limit values of S can be arbitrarily combined.

Examples of the combination for S include more than 0.2 and not more than 1.0, from 0.22-0.8, from 0.24-0.6, and from 0.26-0.4.

MCC in which S satisfies the above range means that the Ni content ratio (mol %) is non-uniform among particles with different particle sizes.

Further, X is 1.6 mol % or more, preferably 1.7 mol % or more, and more preferably 1.8 mol % or more. The upper limit value of X is not particularly limited, but is, for example, 5.0 mol % or less, 4.0 mol % or less, or 3.0 mol % or less.

The above lower limit values and upper limit values of X can be arbitrarily combined. Examples of the combination include 1.6-5.0 mol %, 1.7-4.0 mol %, and 1.8-3.0 mol %.

When X satisfies the above range, it means that the Ni content ratio (mol %) is non-uniform in particles of D₁₀ (μm) or less, that is, in a small particle region.

MCC in which S and X satisfy the above ranges means that the Ni content ratio (mol %) is non-uniform among particles with different particle sizes, and that the Ni content ratio (mol %) varies in the small particle region.

CAM produced using such MCC as a precursor maintains the Ni content ratio (mol %) defined by S and X. In other words, in CAM produced using such MCC as a precursor, the Ni content ratio (mol %) is non-uniform among particles with different particle sizes, and the Ni content ratio (mol %) varies in the small particle region.

When a lithium secondary battery is repeatedly charged and discharged, the CAM particles repeatedly expand and contract, and in this process, degradation phenomena such as the collapse of the CAM particles and the occurrence of cracks in the particles may occur. When a degradation phenomenon occurs, lithium ions cannot be desorbed or inserted, and the cycle retention rate decreases.

CAMs differ in their susceptibility to degradation depending on the particle size and composition. For example, small particles of D₁₀ or less are more likely to collapse in structure, and the higher the Ni content ratio (mol %), the more likely the particles are to crack.

If the Ni content ratio (mol %) varies to such an extent that S is satisfied, the degradation of CAM is unlikely to proceed all at once. Furthermore, if X is satisfied and the Ni content ratio (mol %) varies in the small particle region that is prone to collapse, the degradation of CAM is unlikely to proceed all at once in the small particle region, degradation is less likely to occur overall, and the cycle retention rate of the lithium secondary battery is improved.

A ratio [X/Y] of X and Y in MCC is preferably 3.0 or more, more preferably 4.0 or more, still more preferably 5.0 or more, and particularly preferably 6.0 or more.

The upper limit value of [X/Y] is not particularly limited, but is, for example, 9.0 or less, 8.5 or less, 8.0 or less, or 7.5 or less.

The above lower limit values and upper limit values of [X/Y] can be arbitrarily combined. Examples of the combination include 3.0-9.0, 4.0-8.5, 5.0-8.0, and 6.0-7.5.

X and [X/Y] being within the above ranges means that the difference in the standard deviation (mol %) of the Ni content ratio is large between the small particle region of D₁₀ or less and the large particle region of D₅₀ or more, and that the Ni content ratio (mol %) is non-uniform in the overall MCC.

CAM produced using MCC of the present embodiment as a precursor maintains [X/Y]. In other words, CAM produced using such MCC as a precursor has a non-uniform Ni content ratio (mol %) in the small particle region and the large particle region. Using such CAM, since the degradation of CAM is unlikely to proceed all at once and degradation is less likely to occur overall, the cycle retention rate of the lithium secondary battery is improved.

MCC is preferably represented by the following formula (I):

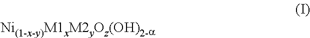

(in the formula (I), 0≤x≤0.8, 0≤y≤0.2, 0<x+y<1, 0≤z≤3, −0.5≤α≤2, and α−z<2; M1 is one or more elements selected from the group consisting of Co, Mn, and Al; and M2 is one or more elements selected from the group consisting of Fe, Cu, Ti, Mg, Zn, Sn, Zr, Nb, Ga, W, Mo, B, and Si.)
   (x)
x is preferably 0.05 or more, and more preferably 0.1 or more.
x is preferably 0.5 or less, more preferably 0.4 or less, and still more preferably 0.3 or less.

The above lower limit values and upper limit values of x can be arbitrarily combined. From the viewpoint of improving the cycle retention rate of the battery, x is preferably from 0-0.5, more preferably from 0.05-0.4, and still more preferably from 0.1-0.3.

(y)
y is preferably 0.15 or less, more preferably 0.1 or less, and still more preferably 0.05 or less.

The above lower limit values and upper limit values of y can be arbitrarily combined. From the viewpoint of improving the cycle retention rate of the battery, y is preferably from 0-0.15, more preferably from 0-0.1, and still more preferably from 0-0.05.

$$( x + y )$$

x+y is preferably more than 0, more preferably 0.03 or more, and still more preferably 0.05 or more.
x+y is preferably 0.7 or less, more preferably 0.6 or less, still more preferably 0.4 or less, and particularly preferably 0.3 or less.

The above lower limit values and upper limit values of x+y can be arbitrarily combined. From the viewpoint of improving the cycle retention rate of the battery, x+y is preferably more than 0 and not more than 0.7, more preferably more than 0 and not more than 0.6, still more preferably from 0.03-0.4, and particularly preferably from 0.05-0.3.

From the viewpoint of obtaining a lithium secondary battery with a high cycle retention rate, an element M2 is preferably one or more elements selected from the group consisting of Ti, Mg, W, Nb, and Zr.

### [Composition Analysis]

The composition of MCC is measured using an ICP optical emission spectrometer after dissolving MCC in hydrochloric acid. As the ICP optical emission spectrometer, for example, Optima 8300 (manufactured by PerkinElmer, Inc.) can be used.

### [Particle Size Distribution Measurement]

The volume-based particle size distribution of MCC is measured by a laser diffraction scattering method. The particle size distribution is measured by charging 250 μL of a 10% by mass sodium hexametaphosphate aqueous solution as a dispersant into Microtrac MT3300EXII manufactured by MicrotracBEL Corporation to obtain a volume-based particle size distribution curve. MCC is added so that the transmittance during measurement is 85±5%.

In the obtained particle size distribution curve, the particle diameter at which the cumulative volume ratio from the small particle side reaches 10% is defined as D₁₀ (μm), the particle diameter at which the cumulative volume ratio from the small particle side reaches 50% is defined as D₅₀ (μm), and the particle diameter at which the cumulative volume ratio from the small particle side reaches 90% is defined as D₉₀ (μm).

The D₅₀ of MCC is preferably 4 μm or more, more preferably 7 μm or more, and still more preferably 9 μm or more. The D₅₀ is preferably 20 μm or less, more preferably 18 μm or less, and still more preferably 15 μm or less.

Regarding the D₅₀ of MCC, the above lower limit values and upper limit values can be arbitrarily combined. Examples of the combination for the D₅₀ of MCC include 4-20 μm, 7-18 μm, and 9-15 μm.

A ratio (D₁₀/D₅₀) of D₁₀ with respect to D₅₀ of MCC is preferably 0.3 or more, more preferably 0.35 or more, and still more preferably 0.40 or more. D₁₀/D₅₀ is preferably 0.8 or less, more preferably 0.75 or less, and still more preferably 0.70 or less.

Regarding the D₁₀/D₅₀ of MCC, the above lower limit values and upper limit values can be arbitrarily combined. Examples of the combination for D₁₀/D₅₀ of MCC include 0.3-0.8, 0.35-0.75, and 0.40-0.70.

A ratio (D₉₀/D₅₀) of D₉₀ with respect to D₅₀ of MCC is preferably 1.4 or more, more preferably 1.45 or more, and still more preferably 1.50 or more. D₉₀/D₅₀ is preferably 1.8 or less, more preferably 1.75 or less, and still more preferably 1.70 or less.

Regarding the D₉₀/D₅₀ of MCC, the above lower limit values and upper limit values can be arbitrarily combined. Examples of the combination for D₉₀/D₅₀ of MCC include 1.4-1.8, 1.45-1.75, and 1.50-1.70.

### <<Method for Producing MCC>>

MCC can be produced by a batch-type coprecipitation method or a continuous-type coprecipitation method. Hereinafter, using a metal composite hydroxide containing Ni and an element M1 as an example, a production method thereof will be described in detail.

First, by using a coprecipitation method, particularly a continuous-type coprecipitation method described in Japanese Unexamined Patent Application, First Publication No. 2002-201028, a nickel salt solution, a metal salt solution of element M1, an alkaline aqueous solution, and, if necessary, a complexing agent are mixed in a reaction tank to produce a metal composite hydroxide containing Ni and the element M1 as an example.

As a nickel salt serving as a solute of the nickel salt solution, for example, one or more of nickel sulfate, nickel nitrate, nickel chloride, and nickel acetate can be used.

As a metal salt serving as a solute of the metal salt solution of element M1, for example, cobalt sulfate, cobalt nitrate, cobalt chloride, cobalt acetate, manganese sulfate, manganese nitrate, manganese chloride, manganese acetate, aluminum sulfate, sodium aluminate, and the like can be used.

The above metal salts are used in a ratio corresponding to the composition ratio of the above composition formula (I). Further, water is used as a solvent.

When the nickel salt solution, the metal salt solution of element M1, the alkaline aqueous solution, and, if necessary, the complexing agent are continuously supplied to the reaction tank, Ni and element M1 react with each other, and nuclei of crystals of Ni(1−x)M1x(OH)2−α are generated. Furthermore, by continuously supplying these raw materials, the nuclei grow. At this time, the nickel salt solution and the metal salt solution of element M1 may be mixed before being supplied to the reaction tank to prepare a mixed solution, and this mixed solution may be supplied to the reaction tank. Further, the nickel salt solution, the metal salt solution of element M1, and the mixed solution may each be supplied to the reaction tank from a plurality of supply ports.

Here, a reaction slurry is a mixture of solids and liquids present in the reaction tank, and more specifically refers to a mixture containing the nickel salt solution, the metal salt solution of element M1, the mixed solution, the complexing agent, the alkaline aqueous solution, and solid contents including precipitates generated by the reaction.

The complexing agent is a compound capable of forming a complex with ions of Ni and element M1 in an aqueous solution. Examples thereof include an ammonium ion donor, hydrazine, ethylenediaminetetraacetic acid, nitrilotriacetic acid, uracildiacetic acid, and glycine.

Examples of the ammonium ion donor include ammonium salts such as ammonium hydroxide, ammonium sulfate, ammonium chloride, ammonium carbonate, and ammonium fluoride.

The complexing agent may not be contained, and when the complexing agent is contained, the amount of the complexing agent contained in the reaction slurry is such that, for example, a molar ratio with respect to the total number of moles of the metal salts contained in the reaction slurry is more than 0 and equal to or less than 2.0.

In the coprecipitation method, in order to adjust the pH value of the above reaction slurry, an alkaline aqueous solution is added to the reaction slurry before the pH of the reaction slurry changes from alkaline to neutral. For the alkaline aqueous solution, an aqueous sodium hydroxide solution or an aqueous potassium hydroxide solution can be used.

The alkaline aqueous solution is not supplied continuously, but is added intermittently. Here, the phrase “added intermittently” refers to a prescription in which a period of dropwise adding into the reaction tank at a constant flow rate and a period of stopping the dropwise addition, in other words, a period where the flow rate is zero, are repeated at a specific cycle. By adding the alkaline aqueous solution intermittently, the pH can be locally lowered in the reaction tank during the period when the addition is stopped, and a period of low pH can be generated. As a result, MCC that satisfies the above S, X, and [X/Y] is obtained.

It should be noted that the pH value in the present specification is defined as a value measured when the temperature of the reaction slurry is 40° C. When the temperature of the reaction slurry sampled from the reaction tank is not 40° C., the reaction slurry is heated or cooled to 40° C. to measure the pH.

During the reaction, a ratio [C1/C2] of C1 representing a solid content concentration (% by mass) of the reaction slurry and C2 representing a nickel concentration (% by mass) of the nickel salt solution is controlled to 1.15 or more and 1.40 or less. Here, the nickel concentration refers to the weight ratio of the nickel element contained in a certain weight of solution.

Furthermore, a ratio [P1/P2] of P1 representing the pH of the nickel salt solution and P2 representing the pH of the reaction slurry is controlled to 0.440 or less. At this time, when the nickel salt solution and the metal salt solution of element M1 are mixed before being supplied to the reaction tank and supplied as a mixed solution, C2 is the nickel concentration (% by mass) of the mixed solution, and P1 is the pH of the mixed solution.

For example, by extracting a certain weight of the reaction slurry from the reaction tank and filtering and drying the extracted slurry to obtain a solid content, the solid content concentration (% by mass) of the reaction slurry can be calculated from a ratio of the dry weight of the solid content and the weight of the extracted slurry. More specifically, it is obtained from a formula: solid content concentration of reaction slurry

$$( \% by mass ) = dry weight of solid content ( g ) / weight of extracted slurry ( g ) \times 100.$$

When [C1/C2] and [P1/P2] are within the above ranges, nickel consumption varies between the nucleation and the nuclear growth, and MCC that satisfies the above S, X, and [X/Y] is obtained.

The materials in the reaction tank are appropriately stirred and mixed.

As the reaction tank used in a continuous-type coprecipitation method, an overflow type reaction tank can be used in order to separate the formed reaction precipitate.

In order to control the atmosphere inside the reaction tank to the desired atmosphere, a predetermined gas may be passed through the reaction tank or the reaction slurry may be directly bubbled.

After the above reaction, the neutralized reaction precipitate is washed with water and then isolated. For the isolation, for example, a method of dehydrating a slurry containing the reaction precipitate (that is, a coprecipitated slurry) by centrifugation, suction filtration or the like is used.

The isolated reaction precipitate is washed, dehydrated, dried and sieved as necessary to obtain a metal composite hydroxide.

After drying MCC, classification may be performed as appropriate.

The reaction precipitate is preferably washed with water, weak acid water, an alkaline cleaning solution, or the like. In the present embodiment, washing with an alkaline cleaning solution is preferred, and washing with an aqueous sodium hydroxide solution or an aqueous potassium hydroxide solution is more preferred.

Furthermore, it is preferable to wash at least once. It is preferable to wash with water, weak acid water, or an alkaline cleaning solution in an amount 10 times or more by mass with respect to the mass of the reaction precipitate, and the temperature of the weak acid water or alkaline cleaning solution is preferably 30° C. or higher. Furthermore, washing is preferably performed at least once.

It should be noted that after washing with a solution other than water, it is preferable to further wash with water so that compounds derived from the cleaning solution do not remain in the reaction precipitate.

The drying temperature is preferably from 80-250° C., and more preferably from 90-230° C. The drying time is preferably from 0.5-30 hours, and more preferably from 1-25 hours. The drying pressure may be either normal pressure or reduced pressure.

When producing a metal composite oxide as MCC, a metal composite hydroxide may be heated to form a metal composite oxide. If necessary, a plurality of heating steps may be performed. In the present specification, the heating temperature means the set temperature of a heating device. In the case of including a plurality of heating steps, it means the temperature when heating is performed at the maximum holding temperature among the heating steps.

The heating temperature is preferably from 300-700° C., and more preferably from 350-680° C. When the heating temperature is from 300-700° C., a metal composite oxide in which the metal composite hydroxide is sufficiently oxidized can be obtained.

The retention time at the above heating temperature may be from 0.1-20 hours, and is preferably from 0.5-10 hours. The rate of temperature increase to the above heating temperature is, for example, from 50-400° C./hour. Further, as the heating atmosphere, air, oxygen, nitrogen, argon, or a mixed gas thereof can be used.

The inside of the heating device may be under an appropriate oxygen-containing atmosphere. The oxygen-containing atmosphere may be a mixed gas atmosphere of an inert gas and an oxidizing gas, or may be a state in which an oxidizing agent is present under an inert gas atmosphere. By having an appropriate oxygen-containing atmosphere inside the heating device, a transition metal contained in the metal composite hydroxide is appropriately oxidized, making it easier to control the form of the metal composite oxide.

The oxygen or oxidizing agent in the oxygen-containing atmosphere only needs to have a sufficient number of oxygen atoms present for oxidizing the transition metal.

When the oxygen-containing atmosphere is a mixed gas atmosphere of an inert gas and an oxidizing gas, the atmosphere in the heating device can be controlled by a method of allowing the oxidizing gas to pass through the heating device, or the like.

As the oxidizing agent, peroxides such as hydrogen peroxide, peroxide salts such as permanganates, perchlorates, hypochlorites, nitric acid, halogens, ozone, and the like can be used.

### <Method for Producing Cathode Active Material for Lithium Secondary Battery>

CAM can be produced using the above-mentioned MCC as a raw material.

A method for producing CAM includes a firing step of firing a mixture of MCC and a lithium compound. The method for producing CAM may include a mixing step of mixing MCC and a lithium compound before the firing step, and may include a washing step of washing the fired product obtained after the firing step.

### [Mixing Step]

MCC and a lithium compound are mixed.

As the lithium compound, one or more selected from the group consisting of lithium carbonate, lithium hydroxide, and lithium hydroxide monohydrate can be used.

The lithium compound and MCC are mixed taking into account the composition ratio of the final target product to obtain a mixture of the lithium compound and MCC.

### [Firing Step]

The obtained mixture is fired. By firing the mixture, CAM crystals grow. The firing step is carried out, for example, at a firing temperature from 500-1,000° C. in an oxygen-containing atmosphere.

The firing temperature in the present specification refers to the temperature of the atmosphere in the firing furnace, and means the maximum temperature of the holding temperature (maximum holding temperature).

When the firing step includes a plurality of firing stages, the firing temperature means the temperature of a stage in which firing is carried out at the maximum holding temperature among the stages.

The firing temperature is preferably from 550-900° C., and more preferably from 600-800° C.

Further, the retention time at the above firing temperature may be, for example, from 0.1-30 hours, and is preferably from 0.5-20 hours.

It is also preferable to fire in an oxygen-containing atmosphere. More specifically, it is preferable to introduce oxygen gas to create an oxygen-containing atmosphere in the firing furnace.

### [Washing Step]

In the present embodiment, the fired product may be washed with a cleaning solution such as pure water or an alkaline cleaning solution. The fired product after washing may be dried as appropriate.

The fired product that has been fired and washed as appropriate is crushed and sieved as appropriate to obtain CAM.

By using MCC having the above configuration, CAM that can increase the cycle retention rate of a lithium secondary battery can be produced.

Further, according to the method for producing CAM as described above, by using the above-mentioned MCC as a raw material, it is possible to suitably produce CAM that has a high cycle retention rate of a lithium secondary battery.

### <Lithium Secondary Battery>

A suitable positive electrode for a lithium secondary battery when the above-mentioned CAM is used will be described. Hereinafter, a positive electrode for a lithium secondary battery may be referred to as a positive electrode.

Furthermore, a lithium secondary battery as a suitable use of a positive electrode will be described.

An example of a suitable lithium secondary battery when using CAM includes a positive electrode and a negative electrode, a separator sandwiched between the positive electrode and the negative electrode, and an electrolytic solution placed between the positive electrode and the negative electrode.

### <All-Solid-State Lithium Secondary Battery>

The above CAM can be used as CAM for an all-solid-state lithium secondary battery.

An example of an all-solid-state lithium secondary battery includes a laminate having a positive electrode, a negative electrode, and a solid electrolyte layer, and an exterior body that houses the laminate. Further, the all-solid-state lithium secondary battery may have a bipolar structure in which CAM and a negative electrode active material are placed on both sides of a current collector. Specific examples of the bipolar structure include structures described in Japanese Unexamined Patent Application, First Publication No. 2004-95400.

### EXAMPLES

Next, the present invention will be described in more detail with reference to Examples.

### <Composition Analysis>

The composition of MCC was analyzed by the method described in the above section entitled [Composition analysis].

### <Measurement of S, X, and Y>

S, X, and Y were measured by the method described in the above section entitled [Measurement of S, X, and Y]. Furthermore, [X/Y] was calculated from the obtained results.

### <Measurement of Cycle Retention Rate>

The cycle retention rate was measured by the method described in the above section entitled [Measurement of cycle retention rate].

### Example 1

Water was placed in a reaction tank equipped with a rotary stirring device having a stirring blade and an overflow pipe, and then an aqueous sodium hydroxide solution was added thereto.

An aqueous nickel sulfate solution, an aqueous cobalt sulfate solution, and an aqueous manganese sulfate solution were mixed in a ratio such that a molar ratio of Ni:Co:Mn was 83.0:5.0:12.0 to prepare a mixed solution 1. Subsequently, the above mixed solution 1 and an aqueous ammonium sulfate solution as a complexing agent were continuously added into the reaction tank under stirring, and an aqueous sodium hydroxide solution was intermittently added thereto to obtain a reaction slurry 1. At this time, while maintaining the temperature of the reaction slurry 1 at 70° C., each solution was added in a ratio such that the slurry concentration of the reaction slurry 1/Ni concentration of the mixed solution 1 (C1/C2) was 1.35 and the pH of the mixed solution 1/pH of the reaction slurry 1 (P1/P2) was 0.432, thereby obtaining a reaction precipitate 1.

The obtained reaction precipitate 1 was isolated, washed, dehydrated, dried, and sieved to obtain a metal composite hydroxide 1.

### Example 2

Water was placed in a reaction tank equipped with a rotary stirring device having a stirring blade and an overflow pipe, and then an aqueous sodium hydroxide solution was added thereto.

An aqueous nickel sulfate solution, an aqueous cobalt sulfate solution, an aqueous manganese sulfate solution, and an aqueous aluminum sulfate solution were mixed in a ratio such that a molar ratio of Ni:Co:Mn:Al was 83.0:11.0:5.0:1.0 to prepare a mixed solution 2.

Subsequently, the above mixed solution 2 and an aqueous ammonium sulfate solution as a complexing agent were continuously added into the reaction tank under stirring, and an aqueous sodium hydroxide solution was intermittently added thereto to obtain a reaction slurry 2. At this time, while maintaining the temperature of the reaction slurry 2 at 71° C., each solution was added in a ratio such that the slurry concentration of the reaction slurry 2/Ni concentration of the mixed solution 2 (C1/C2) was 1.20 and the pH of the mixed solution 2/pH of the reaction slurry 2 (P1/P2) was 0.424, thereby obtaining a reaction precipitate 2.

The obtained reaction precipitate 2 was isolated, washed, dehydrated, dried, and sieved to obtain a metal composite hydroxide 2.

### Comparative Example 1

Water was placed in a reaction tank equipped with a rotary stirring device having a stirring blade and an overflow pipe, and then an aqueous sodium hydroxide solution was added thereto.

An aqueous nickel sulfate solution and an aqueous cobalt sulfate solution were mixed in a ratio such that a molar ratio of Ni:Co was 95.5:4.5 to prepare a mixed solution 3.

Subsequently, the above mixed solution 3, an aqueous ammonium sulfate solution as a complexing agent, and an aqueous sodium hydroxide solution were continuously added into the reaction tank under stirring to obtain a reaction slurry 3. At this time, while maintaining the temperature of the reaction slurry 3 at 70° C., each solution was added in a ratio such that the slurry concentration of the reaction slurry 3/Ni concentration of the mixed solution 3 (C1/C2) was 1.14 and the pH of the mixed solution 3/pH of the reaction slurry 3 (P1/P2) was 0.446, thereby obtaining a reaction precipitate 3.

The obtained reaction precipitate 3 was isolated, washed, dehydrated, dried, and sieved to obtain a metal composite hydroxide 3.

### Comparative Example 2

Water was placed in a reaction tank equipped with a rotary stirring device having a stirring blade and an overflow pipe, and then an aqueous sodium hydroxide solution was added thereto.

An aqueous nickel sulfate solution, an aqueous cobalt sulfate solution, and an aqueous aluminum sulfate solution were mixed in a ratio such that a molar ratio of Ni:Co:Al was 93.0:4.0:3.0 to prepare a mixed solution 4. Subsequently, the above mixed solution 4, an aqueous ammonium sulfate solution as a complexing agent, and an aqueous sodium hydroxide solution were continuously added into the reaction tank under stirring to obtain a reaction slurry 4. At this time, while maintaining the temperature of the reaction slurry 4 at 70° C., each solution was added in a ratio such that the slurry concentration of the reaction slurry 4/Ni concentration of the mixed solution 4 (C1/C2) was 1.23 and the pH of the mixed solution 4/pH of the reaction slurry 4 (P1/P2) was 0.489, thereby obtaining a reaction precipitate 4.

The obtained reaction precipitate 4 was isolated, washed, dehydrated, dried, and sieved to obtain a metal composite hydroxide 4.

### Comparative Example 3

Water was placed in a reaction tank equipped with a rotary stirring device having a stirring blade and an overflow pipe, and then an aqueous sodium hydroxide solution was added thereto.

An aqueous nickel sulfate solution, an aqueous cobalt sulfate solution, and an aqueous aluminum sulfate solution were mixed in a ratio such that a molar ratio of Ni:Co:Al was 88.0:9.0:3.0 to prepare a mixed solution 5. Subsequently, the above mixed solution 5, an aqueous ammonium sulfate solution as a complexing agent, and an aqueous sodium hydroxide solution were continuously added into the reaction tank under stirring to obtain a reaction slurry 5. At this time, while maintaining the temperature of the reaction slurry 5 at 40° C., each solution was added in a ratio such that the slurry concentration of the reaction slurry 5/Ni concentration of the mixed solution 5 (C1/C2) was 1.02 and the pH of the mixed solution 5/pH of the reaction slurry 5 (P1/P2) was 0.433, thereby obtaining a reaction precipitate 5.

The obtained reaction precipitate 5 was isolated, washed, dehydrated, dried, and sieved to obtain a metal composite hydroxide 5.

### Comparative Example 4

Water was placed in a reaction tank equipped with a rotary stirring device having a stirring blade and an overflow pipe, and then an aqueous sodium hydroxide solution was added thereto.

An aqueous nickel sulfate solution, an aqueous cobalt sulfate solution, an aqueous manganese sulfate solution, and an aqueous zirconium sulfate solution were mixed in a ratio such that a molar ratio of Ni:Co:Mn:Zr was 83.9:5.0:10.6:0.5 to prepare a mixed solution 6.

Subsequently, the above mixed solution 6 and an aqueous ammonium sulfate solution as a complexing agent were continuously added into the reaction tank under stirring, and an aqueous sodium hydroxide solution was intermittently added thereto to obtain a reaction slurry 6. At this time, while maintaining the temperature of the reaction slurry 6 at 70° C., each solution was added in a ratio such that the slurry concentration of the reaction slurry 6/Ni concentration of the mixed solution 6 (C1/C2) was 1.34 and the pH of the mixed solution 6/pH of the reaction slurry 6 (P1/P2) was 0.447, thereby obtaining a reaction precipitate 6.

Table 1 below shows the compositions, S, X, X/Y, D₅₀, D₁₀/D₅₀ and D₉₀/D₅₀ of MCCs 1 to 2 produced in Examples 1 to 2 and MCCs 11 to 14 produced in Comparative Examples 1 to 4. Furthermore, the results of the cycle retention rate of lithium secondary batteries using cathode active materials obtained by using MCCs 1 to 2 produced in Examples 1 to 2 and MCCs 11 to 14 produced in Comparative Examples 1 to 4 as raw materials are shown.

TABLE 1

| | | | | | | | | Cycle |
|---|---|---|---|---|---|---|---|---|
| | | | X | | D₅₀ | D₁₀/ | D₉₀/ | retention |
| | Composition | S | (mol %) | X/Y | (μm) | D₅₀ | D₅₀ | rate (%) |
| Ex. 1 | Ni/Co/Mn = | 0.28 | 2.7 | 6.8 | 14.5 | 0.62 | 1.51 | 82 |
| | 83.0/5.0/12.0 | | | | | | | |
| Ex. 2 | Ni/Co/Mn/Al = | 0.31 | 2.0 | 6.7 | 11.6 | 0.59 | 1.61 | 84 |
| | 83.0/11.0/5.0/1.0 | | | | | | | |
| Comp. Ex. 1 | Ni/Co = 95.5/4.5 | 0.09 | 0.6 | 2.0 | 12.6 | 0.56 | 1.56 | 77 |
| Comp. Ex. 2 | Ni/Co/Al = | −0.03 | 0.7 | 2.3 | 12.6 | 0.56 | 1.60 | 73 |
| | 93.0/4.0/3.0 | | | | | | | |
| Comp. Ex. 3 | Ni/Co/Al = | 0.03 | 2.4 | 4.8 | 12.4 | 0.55 | 1.56 | 76 |
| | 88.0/9.0/3.0 | | | | | | | |
| Comp. Ex. 4 | Ni/Co/Mn/Zr = | −0.05 | 0.7 | 3.5 | 12.7 | 0.60 | 1.54 | 71 |
| | 83.9/5.0/10.6/0.5 | | | | | | | |

As described in Table 1, all of the cycle retention rate was as high as 80% or more in Examples 1 to 2 where S was more than 0.2 and X was 1.6 mol % or more.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A metal composite compound comprising at least Ni,
wherein in a scatter plot obtained by measuring a powder of said metal composite compound using a scanning electron microscope-energy dispersive X-ray spectroscopy, with a horizontal axis representing a projected area circle equivalent diameter (μm) of particles of said metal composite compound and a vertical axis representing an Ni content ratio (mol %) of the particles of said metal composite compound, a slope S of an approximate straight line calculated by a least squares method is more than 0.2; and
when a particle diameter at which a cumulative volume ratio from a small particle side in a volume-based particle size distribution reaches 10% is defined as D₁₀ (μm), a standard deviation X of the Ni content ratio (mol %) in particles having a projected area circle equivalent diameter of said D₁₀ (μm) or less is 1.6 mol % or more.

2. The metal composite compound according to claim 1,
wherein when a particle diameter at which the cumulative volume ratio from the small particle side in said particle size distribution reaches 50% is defined as D₅₀ (μm), a ratio of said X and a standard deviation Y of the Ni content ratio (mol %) in particles having a projected area circle equivalent diameter of said D₅₀ (μm) or more is 3.0 or more.

3. The metal composite compound according to claim 1,
wherein D₅₀ (μm), which is a particle diameter at which the cumulative volume ratio from the small particle side in said particle size distribution reaches 50%, is 4 μm or more and 20 μm or less; a ratio (D₁₀/D₅₀) of said D₁₀ (μm) with respect to said D₅₀ (μm) is 0.3 or more and 0.8 or less; and
when a particle diameter at which the cumulative volume ratio from the small particle side in the volume-based cumulative particle size distribution reaches 90% is defined as D₉₀ (μm), a ratio (D₉₀/D₅₀) of said D₉₀ (μm) with respect to said D₅₀ (μm) is 1.4 or more and 1.8 or less.

4. The metal composite compound according to claim 1, which is represented by the following formula (I): 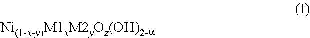
(wherein 0≤x≤0.8, 0≤y≤0.2, 0<x+y<1, 0≤z≤3, −0.5≤α≤2, and α−z<2; M1 is one or more elements selected from the group consisting of Co, Mn, and Al; and M2 is one or more elements selected from the group consisting of Fe, Cu, Ti, Mg, Zn, Sn, Zr, Nb, Ga, W, Mo, B, and Si).
